(19) United States
(12) Patent Application Publication
(10) Pub. No.: US 2023/0093229 A1
(43) Pub. Date: Mar. 23, 2023

(54) REFLECTION STRUCTURE AND VISIBILITY CONTROL METHOD

(71) Applicant: FUJIFILM Corporation, Tokyo (JP)

(72) Inventor: Sohichiro NAKAMURA, Kanagawa (JP)

(73) Assignee: FUJIFILM Corporation, Tokyo (JP)

(21) Appl. No.: 18/054,127

(22) Filed: Nov. 9, 2022

Related U.S. Application Data
(63) Continuation of application No. PCT/JP2021/016819, filed on Apr. 27, 2021.

(30) Foreign Application Priority Data
May 22, 2020 (JP) 2020-090068

(51) Int. Cl. G02B 30/40; G02B 30/60

(52) U.S. Cl. CPC G02B 30/40; G02B 30/60

(57) ABSTRACT

A reflection structure 10 includes a plurality of mutually connected reflection units 20. Each of the plurality of reflection units 20 has a light reflection surface held in a state of maintaining a fixed angle.

This application is a continuation application of International Application No. PCT/JP2021/016819, filed Apr. 27, 2021, the disclosure of which is incorporated herein by reference in its entirety. Further, this application claims priority from Japanese Patent Application No. 2020-090068 filed on May 22, 2020, the disclosures of which is incorporated herein by reference in its entirety.

### BACKGROUND

### 1. Technical Field

The disclosed technology relates to a reflection structure and a visibility control method.

### 2. Description of the Related Art

As a method of obtaining three-dimensional vision, the following technology is known. For example, JP2018-197844A describes a spatial-separation video device that converts one video into a video having depth perception of space by separating the one video into a short-range video and a long-range video, then isolating respective positions of the videos from each other, and recombining the videos together in space. The aforementioned spatial-separation video device includes a semi-transparent mirror that has a structure transparent at a tilt angle and that is provided on a short-range-video front surface.

JP2005-181914A describes a display device that includes a single liquid-crystal display element in which a display surface is divided into a long-range display region and a short-range display region; a polarization separating element disposed on the front surface of the short-range display region; a polarization converting element disposed on the front surface of the long-range display region; and a total reflection mirror that reflects video light radiated from the long-range display region, toward the polarization separating element. Video light radiated from the short-range display region is transmitted through the polarization separating element and observed by an observer. The video light radiated from the long-range display region passes through the polarization separating element, reflected by the total reflection mirror, then reflected by the polarization separating element, and observed by the observer.

### SUMMARY

In urban districts, the habitable area per person and the areas of newly constructed rental apartments and newly constructed houses are decreasing year by year. The views of nature, such as trees, greens, and sky, may alleviate stress of people in cities and sooth the people. It is, however, not necessarily easy to see such views in the neighborhood in daytime, and it takes time to move to see the views. It is considered that work style reform accelerates working from home, and an open space for concentrating on work, sleeping, and relaxing is desired at home.

It may be possible to feel a pseudo open space while staying at home by using the technologies of VR (virtual reality) and AR (augmented reality), which are known as rendering methods using stereoscopic videos. VR and AR are, however, realized with an eyeglass device in most cases. Thus, a non-wearable method is required, for example, when a user wants to relax indoors and concentrate on work.

The disclosed technology has been made in consideration of the aforementioned circumstances, and an object of the disclosed technology is to express visual depth by a non-wearable method.

A reflection structure according to the disclosed technology is a reflection structure including a plurality of mutually connected reflection units, in which each of the plurality of reflection units has a light reflection surface held in a state of maintaining a fixed angle.

Each of the plurality of reflection units may include a reflection member including the light reflection surface on each of both surfaces thereof; and a holding member that holds the reflection member in a state of maintaining the angle of the light reflection surface to be fixed.

The holding member may include a frame member provided along a side of a cube or a rectangular parallelepiped. In this case, the reflection member may be held at a fixed angle tilted with respect to a surface of the cube or the rectangular parallelepiped. The frame member may have a light-transmitting property or may have a light-reflecting property. A part surrounded by the frame member and the reflection member may be a hollow.

In the frame member, a part extending along a side of a portion of the cube or the rectangular parallelepiped may be omitted. The frame member may include a rod-like part extending along a side of the cube or the rectangular parallelepiped, the rod-like part having a triangular prism shape. The reflection structure may further include a cover member that covers a surface of at least part of the plurality of reflection units.

The holding member may include a light-transmitting member having a shape of a cube or a rectangular parallelepiped, and the reflection member may be embedded in an inside of the light-transmitting member at a fixed angle tilted with respect to a surface of the cube or the rectangular parallelepiped.

The plurality of reflection units may be connected together in a first direction and a second direction intersecting the first direction. The plurality of reflection units may be further connected together in a third direction intersecting both the first direction and the second direction.

The plurality of reflection units may be connected together such that an incident position and an emission position of light that passes through an inside of the plurality of reflection units coincide with each other.

The plurality of reflection units may be connected together such that parts that differ from each other in length of a path of light that passes through an inside of the plurality of reflection units are formed.

At least one of a wire, a desiccant, and a flame-retardant material may be housed in an invisible region through which light that passes through an inside of the plurality of reflection units does not pass, the invisible region being surrounded by a plurality of the reflection members.

A visibility control method according to the disclosed technology is a visibility control method in which a distance to a visually recognized object is expressed to be longer than an actual distance, the method including causing the visually recognized object to be visually recognized through a reflection structure including a plurality of mutually connected reflection units each having a light reflection surface held in a state of maintaining a fixed angle.

According to the disclosed technology, it is possible to express visual depth by a non-wearable method.

### BRIEF DESCRIPTION OF THE DRAWINGS

Exemplary embodiments according to the technique of the present disclosure will be described in detail based on the following figures, wherein:

FIG. 1 is a perspective view illustrating one example of the configuration of a reflection structure according to an embodiment of the disclosed technology;

FIG. 2 is a perspective view illustrating one example of the configuration of a reflection unit according to an embodiment of the disclosed technology;

FIG. 3 is a sectional view along line 3-3 in FIG. 1;

FIG. 4A is an image of a pattern drawn on a surface of a sheet;

FIG. 4B illustrates a method of imaging the image illustrated in FIG. 4A;

FIG. 5 is a perspective view illustrating another example of the arrangement of the reflection units;

FIG. 6 is a sectional view along line 6-6 in FIG. 5;

FIG. 7 is a sectional view illustrating another example of the arrangement of the reflection units;

FIG. 8 is a sectional view illustrating another example of the arrangement of the reflection units;

FIG. 9A is a sectional view illustrating another example of the configuration of the reflection unit;

FIG. 9B is a sectional view illustrating one example of the connected form of a plurality of the reflection units;

FIG. 10 is a sectional view (X-Z sectional view) illustrating another example of the configuration of the reflection structure;

FIG. 11A is a perspective view illustrating one example of the configuration of a reflection unit according to another embodiment of the disclosed technology;

FIG. 11B is a sectional view along line 11B-11B in FIG. 11A;

FIG. 12 is an exploded perspective view of components of the reflection unit according to an embodiment of the disclosed technology; and

FIG. 13 illustrates one example of an image of an observation object visually recognized through the reflection structure according to an embodiment of the disclosed technology.

### DETAILED DESCRIPTION

Hereinafter, one example of an embodiment of the disclosed technology will be described with reference to the drawings. In the drawings, the same or equivalent components and parts are given the same reference signs, and duplicate description will be omitted, as appropriate.

### First Embodiment

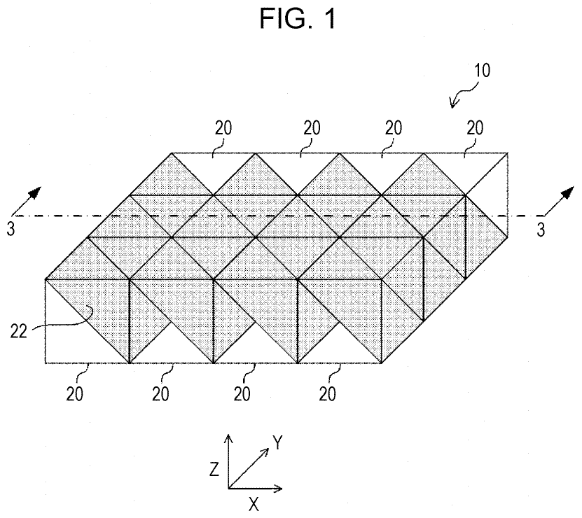

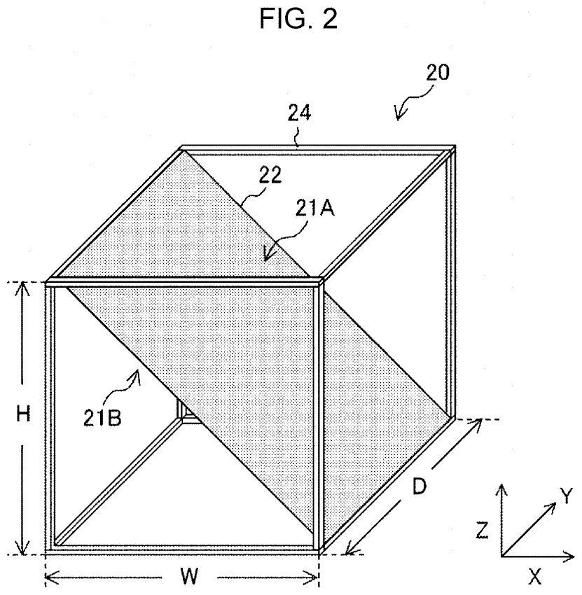

FIG. 1 is a perspective view illustrating one example of the configuration of a reflection structure 10 according to an embodiment of the disclosed technology. FIG. 2 is a perspective view illustrating one example of the configuration of a single reflection unit 20 constituting the reflection structure 10. The reflection structure 10 is constituted by a plurality of the reflection units 20 that are mutually connected. In FIG. 1, an example in which the plurality of reflection units are connected together in the X-direction and the Y-direction orthogonal to the X-direction is illustrated. The number of reflection units 20 included in the reflection structure 10 can be increased or decreased, as appropriate.

Each reflection unit 20 includes a reflection member 22 having light reflection surfaces held in a state of maintaining a fixed angle. The reflection member 22 is a plate-like, sheet-like, or film-like member including light reflection surfaces 21A and 21B on both surfaces thereof. The reflectivity of the light reflection surfaces 21A and 21B is preferably, for example, 90% or more, and light transmittance thereof is preferably substantially zero. As the reflection member 22, for example, a mirror that is vapor-deposited on an acrylic plate or a PET film that is commercially available is usable. The reflection unit 20 has a frame member 24 that functions as a holding member that holds the reflection member 22 in a state of maintaining the angle of the light reflection surfaces 21A and 21B to be fixed.

The outer shape of the reflection unit 20 is, for example, a cube or a rectangular parallelepiped. In other words, a width W, a depth D, and a height H thereof may be equal to each other. The width W is a length in the X-direction, the depth D is a length in the Y-direction, and the height H is a length in the Z-direction. The Z-direction is a direction perpendicular to both the X-direction and the Y-direction. The depth D may be longer than the width W and the height H by any length.

The frame member 24 is constituted by, for example, a combination of rod-like members provided along the sides defining the outer shape of the cube or the rectangular parallelepiped of the reflection unit 20. In the present embodiment, the frame member 24 is constituted by a material, such as resin, having a light-transmitting property. The frame member 24 may be constituted by, for example, a combination of a plurality of acrylic rods. In the reflection unit 20, a region surrounded by the frame member 24 and the reflection member 22 is a hollow. The reflection member 22 is held at a fixed angle tilted with respect to an imaginary surface of the cube or the rectangular parallelepiped that is the outer shape of the reflection unit 20.

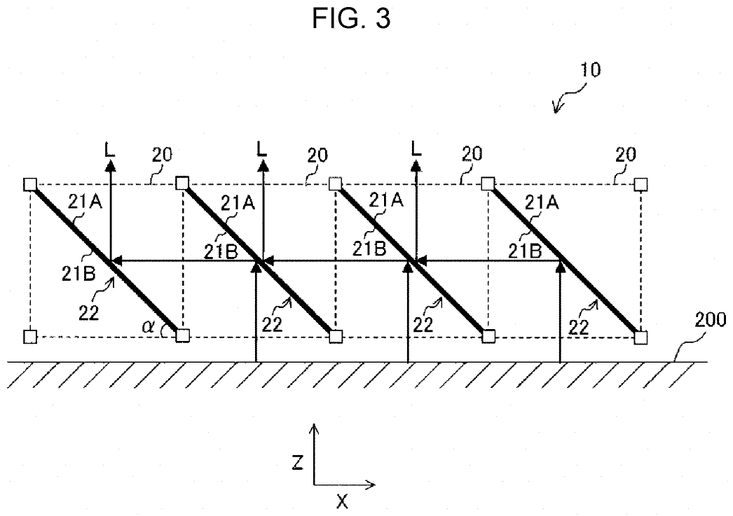

FIG. 3 is a sectional view (X-Z sectional view) along line 3-3 in FIG. 1 and illustrates one example of an effect of the reflection structure 10 constituted by the plurality of mutually connected reflection units 20. The reflection structure 10 is disposed between an observation object (visually recognized object) 200 and an observer (not illustrated) who observes the observation object 200. In other words, the image of the observation object 200 is visually recognized by the observer through the reflection structure 10. The reflection structure 10 may be in close contact with the observation object 200 and may be spaced from the observation object 200. Each of the reflection units 20 is connected to the other reflection units 20 such that, for example, the direction of the light reflection surfaces 21A and 21B is parallel to the direction of those of the other reflection units 20. In the example illustrated in FIG. 3, a tilt angle α of the light reflection surfaces 21A and 21B with respect to the X-direction parallel to the surface of the observation object 200 is 45°.

In FIG. 3, light L radiated from the observation object 200 and incident on each reflection unit 20 in the Z-direction perpendicular to the surface of the observation object 200 is illustrated. The light L incident on each reflection unit 20 is reflected by the light reflection surface 21B of the reflection unit 20, the traveling direction of the light L is bent from the Z-direction to the X-direction, and the light L is incident on an adjacent reflection unit 20 on the left side in FIG. 3. Thereafter, the light L is reflected by the light reflection surface 21A, the traveling direction of the light L is bent from the X-direction to the Z-direction, and the light L is emitted to the outside of the reflection units 20 to be visually recognized by an observer.

As described above, the light radiated from the observation object 200 reaches the observer by passing through the inside of the reflection structure 10 and thereby bending the traveling direction. Thus, the length of the path of the light L is longer than when the light radiated from the observation object 200 reaches the observer without being bent (in other words, when the observation object 200 is visually recognized directly by the observer). Consequently, it is possible to cause the observation object 200 to be visually recognized as an object present at a farther distance by the observer than when the observation object 200 is visually recognized directly by the observer.

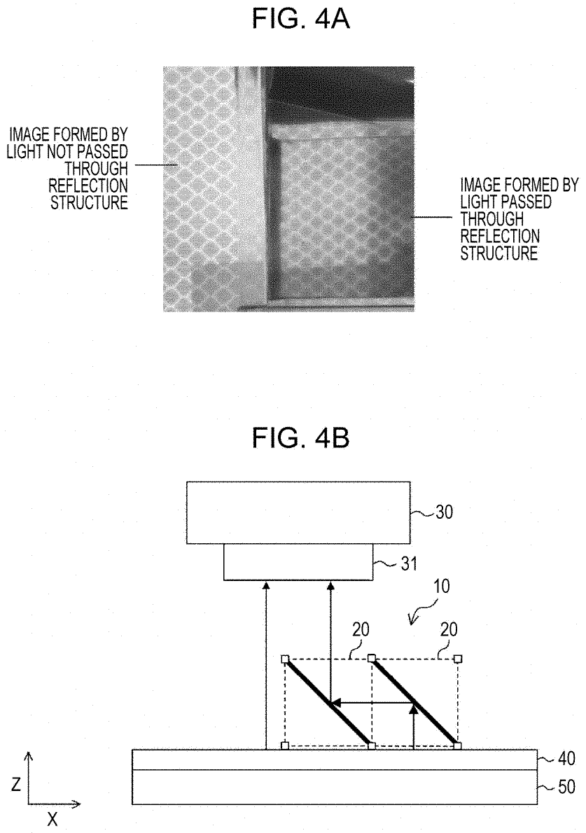

FIG. 4A is an image of a pattern drawn on the surface a sheet 40, which is an observation object, imaged by an imaging device 30 illustrated in FIG. 4B. Imaging is performed with the reflection structure 10 mounted on a surface of the sheet 40 on which the pattern is drawn and with the imaging device 30 disposed such that both the light that is emitted from the surface of the sheet 40 and passes through the reflection structure 10 and the light that is emitted from the surface of the sheet 40 and does not passes through the reflection structure 10 are incident on a lens 31 of the imaging device 30. At this time, an illumination panel 50 is disposed at the back surface of the sheet 40, and the sheet 40 having a light-transmitting property is irradiated from the back surface side thereof with illumination light. As illustrated in FIG. 4A, the image formed by the light passed through the reflection structure 10 is visually recognized to be present at a farther distance than the image formed by the light not passed through the reflection structure 10.

As described above, by causing an observation object to be visually recognized by an observer through the reflection structure 10, it is possible to cause a distance to the observation object to be visually recognized as a distance longer than an actual distance, in other words, possible to express a visual depth by a non-wearable method. For example, by installing the reflection structure 10, which is constituted by the plurality of reflection units 20 connected together in the X-direction and the Y-direction, on a ceiling or a wall of a room, it is possible to increase the sense of distance to the ceiling or the wall and possible to cause the room to be visually recognized to be spacious.

In addition, it is possible to freely determine the number and the arrangement of the reflection units 20 since the reflection structure 10 is constituted by the plurality of mutually connected reflection units 20. It is thus possible flexibly cope with a variation in the size and the shape of an observation object (for example, a ceiling or a wall).

In addition, since the region surrounded by the frame member 24 and the reflection member 22 is a hollow in each reflection unit 20, the light for illuminating the observation object 200 can be taken in from the outside. In other words, natural light can be used as a light source for illuminating the observation object 200, which eliminates the need to additionally provide a light source for illuminating the observation object 200. As illustrated in FIG. 4B, it is also possible to dispose the illumination panel 50 at the back surface side of the observation object 200, as necessary, to illuminate the observation object 200. In addition, due to the frame member 24 constituted by a member having a light-transmitting property, it is possible to suppress the visibility of the observation object 200 from being hindered by the frame member 24.

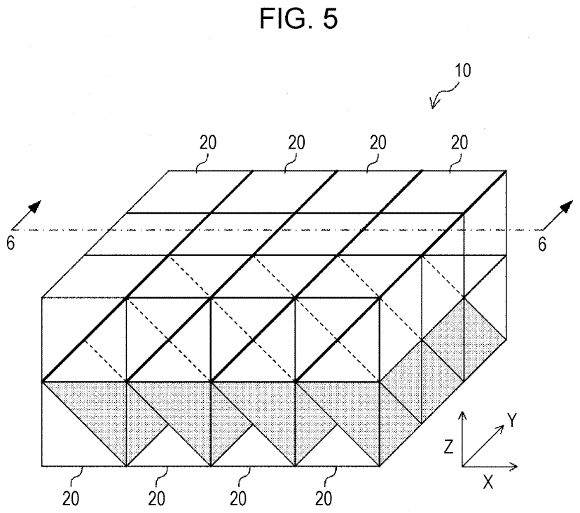

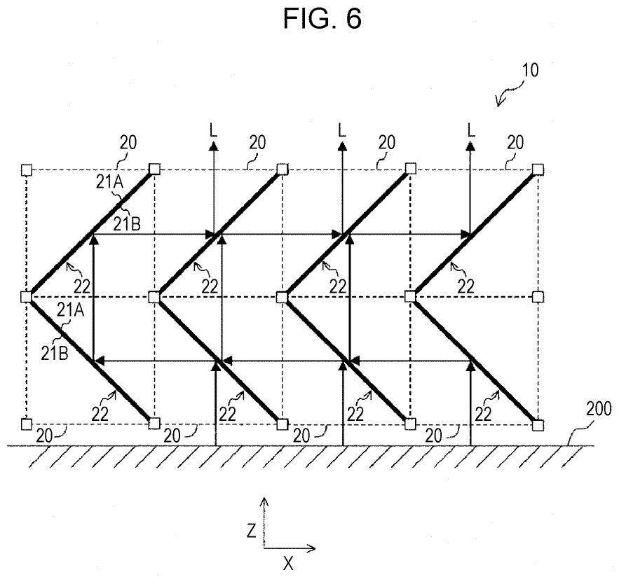

FIG. 5 is a perspective view illustrating another example of the arrangement of the reflection units 20 in the reflection structure 10. FIG. 6 is a sectional view (X-Z sectional view) along line 6-6 in FIG. 5. As illustrated in FIG. 5 and FIG. 6, the plurality of reflection units 20 may be connected together in the X-direction and the Y-direction while being connected together in the Z-direction orthogonal to both the X-direction and the Y-direction. In other words, the plurality of reflection units 20 may be disposed side by side on the X-Y plane parallel to the surface of the observation object 200 while being stacked in the Z-direction perpendicular to the surface of the observation object 200.

In the example illustrated in FIG. 5 and FIG. 6, the reflection units 20 on the side (lower stage side) close to the observation object 200 are connected together such that the directions of respective light reflection surfaces 21A and 21B are parallel to each other, and the reflection units 20 on the side (upper stage side) far from the observation object 200 are connected together such that the directions of respective light reflection surfaces 21A and 21B are orthogonal to the directions of the light reflection surfaces 21A and 21B of the reflection units 20 on the side (lower stage side) close to the observation object 200. Due to the plurality of reflection units 20 connected together in the aforementioned form, it is possible to cause the incident position and the emission position in the X-Y direction of the light L that passes through the inside of the plurality of reflection units 20 constituting the reflection structure 10 to coincide with each other.

For example, as illustrated as an example in FIG. 3, when the number of stacks of the reflection units 20 in the Z-direction perpendicular to the surface of the observation object 200 is one, the position of the image of the observation object 200 is visually recognized in a stage of being shifted in the X-direction by an observer. Meanwhile, it is possible to avoid the position of the image of the observation object 200 from being visually recognized in the shifted state by the observer by, as illustrated as an example in FIG. 6, setting the number of stacks of the reflection units 20 in the Z-direction perpendicular to the surface of the observation object 200 to two or more and connecting the plurality of reflection units 20 together such that the incident position and the emission position in the X-Y direction of the light L that passes through the inside of the reflection structure 10 coincide with each other.

In addition, by connecting the plurality of reflection units 20 together not only in the X-Y direction but also in the Z-direction, it is possible to increase the length of the path of the light L that passes through the inside of the reflection structure 10. Consequently, it is possible to promote the effect of causing the observation object 200 to be visually recognized as an object present at a farther distance than an actual distance by an observer.

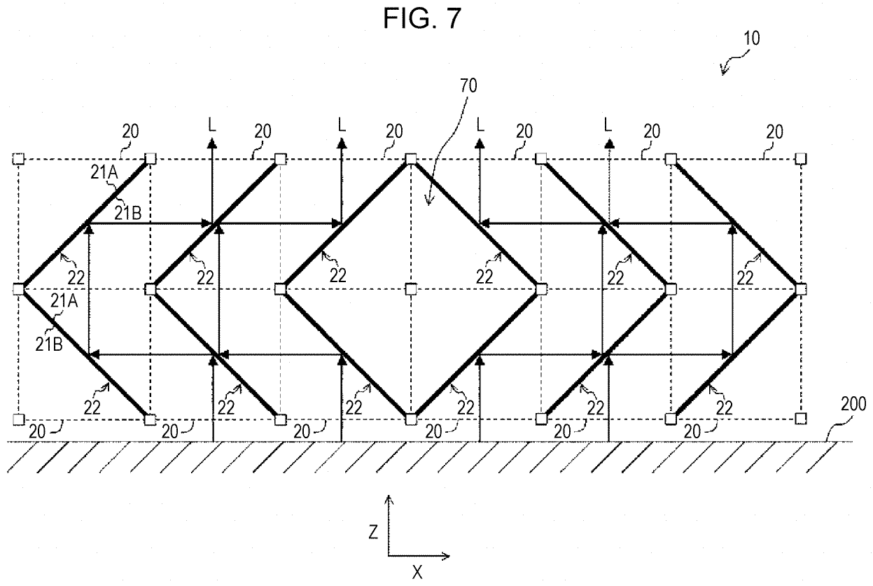

FIG. 7 is a sectional view (X-Z sectional view) illustrating another example of the arrangement of the reflection units 20 in the reflection structure 10. In the example illustrated in FIG. 7, among the reflection units 20 on the side (lower stage side) close to the observation object 200, the three reflection units 20 on the left side are connected together such that the directions of respective light reflection surfaces 21A and 21B are parallel to each other, and the three reflection units 20 on the right side are connected together such that the directions of respective light reflection surfaces 21A and 21B are orthogonal to the directions of the light reflection surfaces 21A and 21B of the three reflection units 20 on the left side. The reflection units 20 on the side (upper stage side) far from the observation object 200 are connected together such that the directions of respective light reflection surfaces 21A and 21B are orthogonal to the directions of the light reflection surfaces 21A and 21B of the reflection units 20 adjacent thereto in the Z-direction on the side (lower stage side) close to the observation object 200. Even when the plurality of reflection units 20 are connected together in the aforementioned form, it is possible to avoid the position of the image of the observation object 200 from being visually recognized in a shifted state by an observer. Further, an invisible region 70 surrounded by a plurality of the reflection members 22 and through which the light L does not pass is present at a central portion of the reflection structure 10 illustrated in FIG. 7. Wires such as an electric wire and a LAN cable may be housed in the invisible region 70, and a desiccant and a flame-retardant material may be enclosed in the invisible region 70. A light source such as a fluorescent lamp may be housed in the invisible region 70, a portion of the reflection member 22 may be provided with a through hole through which light from the light source passes, and the light that has been emitted from the light source and has passed through the through hole may be caused to irradiate the observation object 200 to illuminate the observation object 200. The light that has been emitted from the light source and has passed through the through hole may be caused to be radiated toward an observer. As described above, the reflection structure 10 illustrated in FIG. 7 is usable as a system in which the entirety or part of wires and a light source is housed in the invisible region 70.

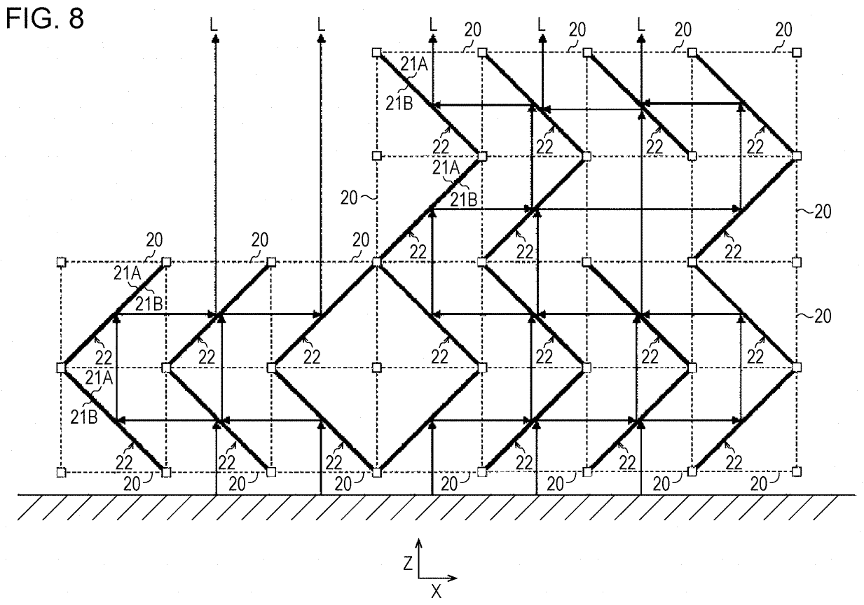

FIG. 8 is a sectional view (X-Z sectional view) illustrating another example of the arrangement of the reflection units 20 in the reflection structure 10. The reflection structure 10 illustrated as an example in FIG. 8 has parts that differ from each other in the number of stacks of the reflection units 20 in the Z-direction perpendicular to the surface of the observation object 200, and a part in which the reflection member 22 is thinned out. Connecting the plurality of reflection units 20 together in the aforementioned form forms parts that differ from each other in length of the path of the light L that passes through the inside of the plurality of reflection units 20 constituting the reflection structure 10. It is thus possible to cause the sense of distance to the observation object 200 to be visually recognized to be different depending on the position by an observer.

In the above description, the frame member 24 constituted by the combination of the rod-like members provided along the sides defining the outer shape of the cube or the rectangular parallelepiped of the reflection unit 20 is presented as an example. In the frame member 24, however, a part extending along a side of a portion of the cube or the rectangular parallelepiped may be omitted. Omission of a portion of the frame member 24 can reduce a part shaded by the frame member 24 in an image visually recognized through the reflection structure 10.

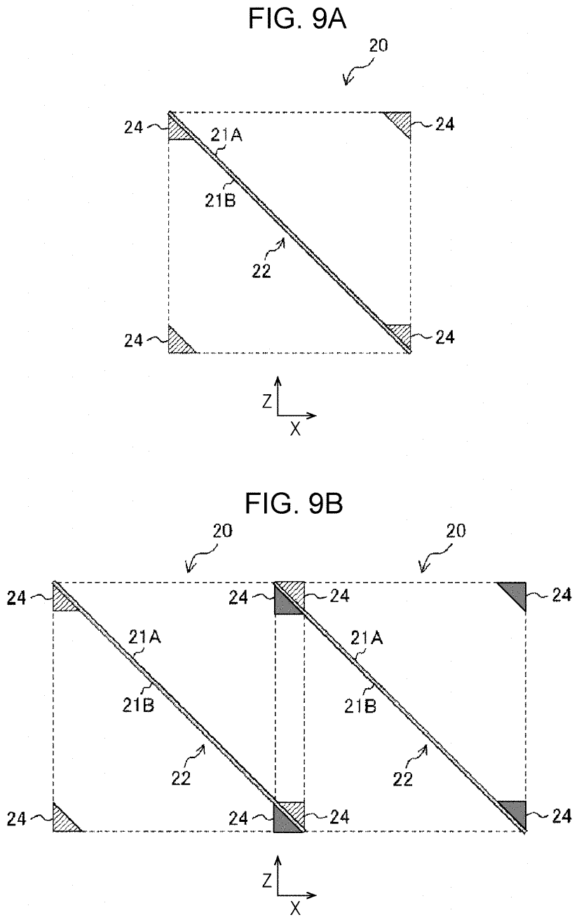

FIG. 9A is a sectional view (X-Z sectional view) illustrating another example of the configuration of the reflection unit 20. In the example illustrated in FIG. 9A, the shape of each of parts (hereinafter referred to as the rod-like parts) of the frame member 24 extending along the sides defining the outer shape of the reflection unit 20 is a triangular prism shape. The reflection member 22 is supported by the rod-like parts of the frame member 24 being in contact with the reflection member 22 so as to extend along the two mutually opposite sides of the reflection member 22. One of the rod-like parts in contact with the reflection member 22 is provided on the side of the light reflection surface 21A. Another one of the rod-like parts in contact with the reflection member 22 is provided on the side of the light reflection surface 21B. Consequently, it is possible to support the reflection member 22 more stably. In addition, since the shape of each of the rod-like parts not in contact with the reflection member 22 is also a triangular prism shape, it is possible to avoid interference between the frame members 24 at the connecting part thereof when a plurality of the reflection units 20 are connected together as illustrated in FIG. 9B.

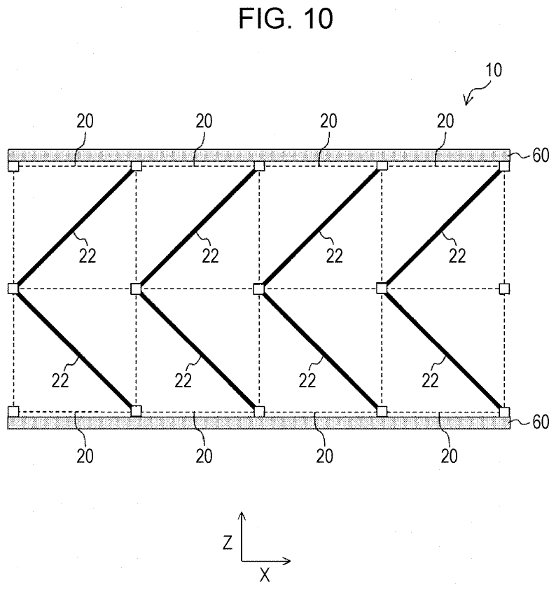

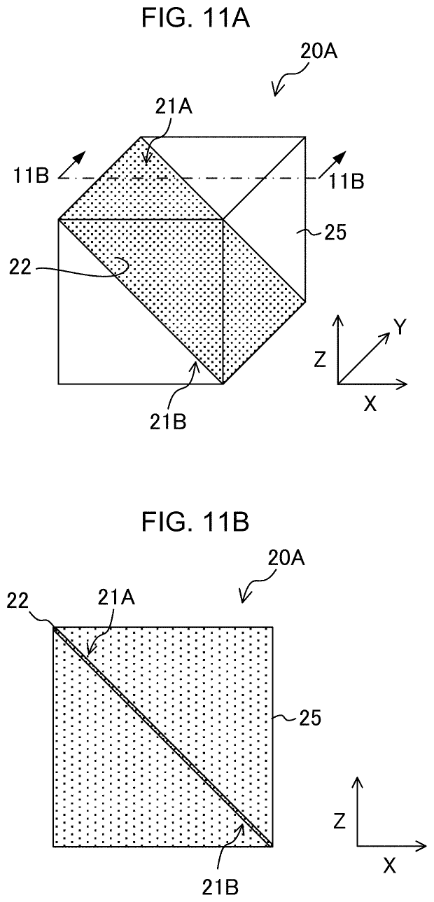

FIG. 10 is a sectional view (X-Z sectional view) illustrating another example of the configuration of the reflection structure 10. As illustrated in FIG. 11, the reflection structure 10 may include a cover member 60 that integrally covers the surface of at least part of the plurality of reflection units 20. In FIG. 10, a form in which the entirety of the upper surfaces and the entirety of the lower surfaces of the plurality of reflection units 20 are each covered by the cover member 60 is illustrated as an example. Alternatively, part of the upper surfaces and part of the lower surfaces of the plurality of reflection units 20 may be each covered by the cover member 60. Part or the entirely of the side surfaces of the plurality of reflection units 20 may be covered by a cover member. The cover member 60 is constituted by a member, such as glass and resin, having a light-transmitting property. By covering the surfaces of the reflection units 20 with the cover member 60 as described above, it is possible to suppress foreign matters, such as dust, from entering into the inside of the reflection units 20. It is also possible to increase the mechanical strength and heat resistance of the reflection structure 10. Both surfaces of the cover member 60 may be each provided with an adhesive layer.

In the aforementioned embodiment, an example in which the frame member 24 is constituted by a member having a light-transmitting property is presented. The frame member 24, however, may be constituted by a member, such as metal, having a light-reflecting property. With the frame member 24 constituted by a member having a light-reflecting property, an image reflected by the frame member 24 is visually recognized by an observer. It is thus possible to achieve more intricate visual expression.

### Second Embodiment

FIG. 11A is a perspective view illustrating one example of the configuration of a reflection unit 20A according to a second embodiment of the disclosed technology. FIG. 11B is a sectional view along line 11B-11B in FIG. 11A. The reflection unit 20A according to the present embodiment has a light-transmitting member 25 as a holding member that holds the reflection member 22 in a state of maintaining the angle of light reflection surfaces to be fixed. The light-transmitting member 25 is constituted by a member, such as glass and resin, having a light-transmitting property and has a shape of a cube or a rectangular parallelepiped. The reflection member 22 is embedded in the inside of the light-transmitting member 25 at a fixed angle tilted with respect to a surface of the cube or the rectangular parallelepiped of the light-transmitting member 25.

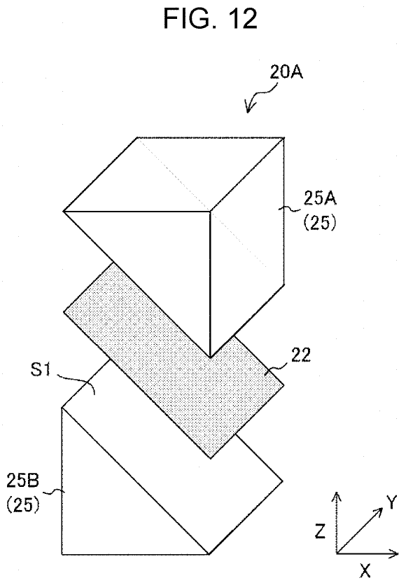

FIG. 12 is an exploded perspective view of components of the reflection unit 20A. As illustrated in FIG. 12, the light-transmitting member 25 may include a first part 25A and a second part 25B divided from each other along the surface where the reflection member 22 extends and each having a triangular prism shape. The reflection member 22 is held in a state of being sandwiched between the first part 25A and the second part 25B of the light-transmitting member 25. The reflection member 22 may be constituted by a light reflection film formed by using a film formation method such as vapor deposition or coating on a joint surface 51 of the second part 25B joined to the first part 25A. In this case, a joint surface of the first part 25A joined to the second part 25B is not required to be provided with a light reflection film. In other words, the light reflection film may be provided on only the joint surface of one of the first part 25A and the second part 25B.

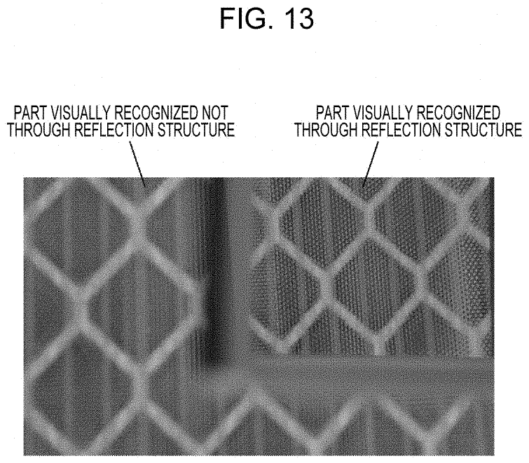

By connecting a plurality of the reflection units 20A to constitute a reflection structure, it is possible to express visual depth as with the reflection structure 10 constituted by the mutually connected reflection units 20 according to the first embodiment. FIG. 13 illustrates one example of an image of an observation object visually recognized through a reflection structure that includes a reflection unit. The reflection unit has the light-transmitting member 25 made of glass and a light reflection film formed on a surface of the light-transmitting member 25 by vapor deposition of aluminum. In FIG. 13, a part visually recognized through the reflection structure having the aforementioned configuration and a part visually recognized not through the reflection structure are illustrated. As illustrated in FIG. 13, it was confirmed that the observation object is visually recognized as an object present at a farther distance than an actual distance by an observer.

Note that the entire content of the disclosure of JP2020-090068 filed on May 22, 2020 is incorporated in the present specification by reference. In addition, all of the documents, the patent applications, and the technical standards described in the present specification are incorporated in the present specification by reference to the same extend as if each of the documents, the patent applications, and the technical standards is specifically and individually indicated to be incorporated by reference.

What is claimed is:

1. A reflection structure comprising a plurality of mutually connected reflection units,
wherein each of the plurality of reflection units has a light reflection surface held in a state of maintaining a fixed angle.

2. The reflection structure according to claim 1,
wherein each of the plurality of reflection units includes
a reflection member including the light reflection surface on each of both surfaces thereof, and
a holding member that holds the reflection member in a state of maintaining the angle of the light reflection surface to be fixed.

3. The reflection structure according to claim 2,
wherein the holding member includes a frame member provided along a side of a cube or a rectangular parallelepiped, and
wherein the reflection member is held at a fixed angle tilted with respect to a surface of the cube or the rectangular parallelepiped.

4. The reflection structure according to claim 3,
wherein the frame member has a light-transmitting property.

5. The reflection structure according to claim 3,
wherein the frame member has a light-reflecting property.

6. The reflection structure according to claim 3,
wherein a region surrounded by the frame member and the reflection member is a hollow.

7. The reflection structure according to claim 3,
wherein, in the frame member, a part extending along a side of a portion of the cube or the rectangular parallelepiped is omitted.

8. The reflection structure according to claim 3,
wherein the frame member includes a rod-like part extending along a side of the cube or the rectangular parallelepiped, the rod-like part having a triangular prism shape.

9. The reflection structure according to claim 1, further comprising:
a cover member that covers a surface of at least part of the plurality of reflection units.

10. The reflection structure according to claim 2,
wherein the holding member includes a light-transmitting member having a shape of a cube or a rectangular parallelepiped, and
wherein the reflection member is embedded in an inside of the light-transmitting member at a fixed angle tilted with respect to a surface of the cube or the rectangular parallelepiped.

11. The reflection structure according to claim 1,
wherein the plurality of reflection units are connected together in a first direction and a second direction intersecting the first direction.

12. The reflection structure according to claim 11,
wherein the plurality of reflection units are connected together in a third direction intersecting both the first direction and the second direction.

13. The reflection structure according to claim 1,
wherein the plurality of reflection units are connected together such that an incident position and an emission position of light that passes through an inside of the plurality of reflection units coincide with each other.

14. The reflection structure according to claim 1,
wherein the plurality of reflection units are connected together such that parts that differ from each other in length of a path of light that passes through an inside of the plurality of reflection units are formed.

15. The reflection structure according to claim 2,
wherein at least one of a wire, a desiccant, and a flame-retardant material is housed in an invisible region through which light that passes through an inside of the plurality of reflection units does not pass, the invisible region being surrounded by a plurality of the reflection members.

16. A visibility control method in which a distance to a visually recognized object is expressed to be longer than an actual distance, the method comprising:
causing the visually recognized object to be visually recognized through a reflection structure including a plurality of mutually connected reflection units each having a light reflection surface held in a state of maintaining a fixed angle.
